(19) United States
(12) Patent Application Publication
(10) Pub. No.: US 2002/0038284 A1
(43) Pub. Date: Mar. 28, 2002

(54) Method for electronically setting credits and system therefor

(76) Inventor: Muneyasu Fukunaga, Osaka (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/923,382

(22) Filed: Aug. 8, 2001

(30) Foreign Application Priority Data
Aug. 8, 2000 (JP) 2000-239504

(51) Int. Cl. G06F 17/60

(52) U.S. Cl. 705/38; 705/39

(57) ABSTRACT

The present invention provides a method for electronically setting credits and a system therefor wherein the rights of a membership having asset value, such as a golf membership, can be enjoyed while a credit line with this membership as security can be attained quickly over a network, and moreover, maximum use can be made of the asset value thereof as security. This method and system are constituted with a terminal device operated by the member, a membership management device possessed by the membership issuing organization, a credit line management device possessed by a credit granting organization, and an information brokering management device possessed by a credit brokering organization and connected with each of these devices through a telecommunications network.

### BACKGROUND OF THE INVENTION

1. Field of the Invention

The present invention relates to a method for electronically setting credits and a system therefor.

2. Description of the Related Art

In recent years, the technology relating to computers, personal computers, and telecommunications systems has developed markedly. Born from that process, the Internet has expanded at a speed that far exceeded expectations. Because it has become possible to read and send electronic information from home using the Internet, commercial transaction systems using the Internet are highlighted as systems for purchasing products that do not require one to go into a retail store and are spreading rapidly. The most general form of this commercial transaction system using the Internet is that wherein products are posted on a home page, the user accesses that home page, selects a posted product, and orders the product from the home page. Meanwhile, payment is made through a settlement system between the user and a credit company based on a credit number sent at the time the order is made. This settlement by credit is based on an agreement between the user and credit company and this credit agreement is one wherein a credit line is established within the range of a standard amount of money that is generally unsecured and based on a preliminary examination.

With the recent golf boom, however, golf courses are being constructed at locations throughout country and the number of golf lovers is well on the increase. Golf courses generally use a membership system, wherein a person who has purchased a golf membership is guaranteed to be able to use the golf course at a lower rate than that for nonmembers. In other words, this golf membership is the right to use the golf course at a discounted fee and can be bought or sold as a property right; and a market is therefore formed. In effect, this golf membership is an asset and is said to have value as a security.

If, while enjoying the right to use the golf course at a discounted fee, one could quickly be granted over the Internet a credit line for credit payments in commercial transactions through the Internet as discussed above with this golf membership as security, that credit could be promptly used for commercial transactions on the Internet. Also, this could be a new method for using a golf membership, if one could use the full value of the golf membership as security without adhering to a credit line determined in advance by a preliminary examination as in regular credit. For example, when a credit line determined by appraising the value of the golf membership is greater than the credit line determined by a preliminary examination for regular credit, one can use that greater credit line and this can be a new method wherein that golf membership is used with maximum effectiveness as collateral. Moreover, at the stage of establishing the golf membership as security, one can generally exercise the basic right to be able to use the golf course in which one has membership; one can therefore enjoy the basic rights for the asset of membership, while being able to use a credit line with that asset as security. Also, the idea of using the golf membership as security with maximum effectiveness also makes it possible to realize a situation wherein the security interest can be established at any time, by having procedures for prohibiting the transfer of title to the membership even if the security interest is not actually established, for example. Such a system, however, does not exist at this time.

### SUMMARY OF THE INVENTION

The present invention was made in order to cope with these aspects and it is an object of the present invention to provide a method for electronically setting credits and a system therefor with which one can quickly acquire a credit line over a network or the like with this membership as security and make the maximum use of the value of that asset as security, while enjoying the regular rights of a membership, having value as an asset such as a golf membership.

Relating to the establishment of a credit line by a credit company or the like, it is easier for the credit establishing side if there is security rather than not and if there is a marketplace provided for evaluating the collateral to determine the credit line and in the case of the loan becoming unrecoverable, and in which the collateral can be liquidated quickly, easily, and at the greatest value possible. It is easier for the receiving side to be able to employ the rights associated with the security while using the established credit line. This is also valid in the case where the establishment of security interest can be carried out immediately by having procedures or the like to prohibit the transfer of title to the collateral, even without actually establishing security interest for the collateral. When one considers golf memberships from this perspective, as discussed above, the rights of the golf membership, such as using the golf course, can be exercised even when security interest is generally established; at the same time, a marketplace for buying and selling golf memberships is established and the appraisal and liquidation thereof is comparatively easy. The present invention, a method for electronically setting credits and a system therefor, was established with attention to these issues.

The method for electronically setting credits relating to the present invention is explained first. A first method for electronically setting credits relating to the present invention is specifically the following type of method.

This is a method for electronically setting credits, wherein a terminal device operated by a person owning a membership, hereinafter “member”, a membership management device possessed by the membership issuing organization, and a credit line management device possessed by a credit granting organization are connected through a telecommunications network with an information brokering management device possessed by a credit brokering organization for brokering the exchange of information among each of the organizations; and this information brokering management device receives credit line application information sent from the terminal device and sends this to the credit line management device, and receives information on the credit line determined by the credit granting organization, for the membership belonging to the member, from the credit line management device and sends this information to the terminal device; upon receiving consent information decided upon by the member for the credit line from the terminal device, this information brokering management device issues a command for the processing to prohibit the transfer of the membership title to the membership management device on the basis of this consent information, the membership management device gets the command, but is not necessarily the agent to perform the process; after the processing to prohibit the transfer of title is performed by the membership issuing organization, this information brokering management device receives the information regarding the completion of the processing to prohibit the transfer of title from the membership management device, and issues a command for establishing a credit line on the basis of the credit line information to the credit line management device; and this information brokering management device receives the notification that the credit line has been established from the credit line management device and sends this notification to the terminal device.

With the first method for electronically setting credits, a terminal device operated by a member having a membership such as a golf membership, a membership management device possessed by a membership issuing organization for managing memberships, and a credit line management device possessed by a credit granting organization for establishing credit lines for members on the basis of memberships are used in connection to an information brokering management device, possessed by a credit brokering organization for brokering the exchange of information among each of the devices, through a telecommunications network. FIG. 1 shows the situation. The member and each organization are provided some kind of device as means for conducting communications. For example, the member has a telephone, personal computer, a portable phone, or PDA (personal digital assistant), or the like; the membership issuing organization and credit granting organization have personal computers or computers. Each terminal device 2, membership management device 4, and credit management device 5, which are telephones, personal computers, computers, or the like, are connected through a telecommunications network 9 with an information brokering management device 1, such as a personal computer or computer established in a credit brokering organization.

FIG. 2 is a drawing to explain the operation of this first method for electronically setting credits. The operation and action of the first method for electronically setting credits are explained below using FIG. 2. Moreover, the T characters in the drawing indicates the information processing steps.

In FIG. 2, in the case where the member owning the membership wants to establish a credit line with the membership as security in order to go shopping or the like over a network such as the Internet, the member sends the credit line application information from the terminal 2, such as a telephone or personal computer, to the information brokering management device 1 (T1). The information brokering management device 1 receives this credit line application information (T2) and sends this information to the credit line management device 5 (T3). This corresponds to the process (a) in FIG. 2. When the credit line management device 5 receives the credit line application information (T4), the credit granting organization independently evaluates of the member's membership on the basis of this credit line application information and determines the credit line, such as the amount of credit. Thereupon, the credit line management device 5 sends this credit line information to the information brokering management device 1 (T5).

When the information brokering management device 1 receives this information (T6), the device 1 sends the provided credit information to the terminal device 2 (T7). When the terminal device 2 receives this information (T8), the member decides whether to consent to the establishment of this credit line under the conditions such as the amount of credit provided in the credit line information. The terminal device 2 then sends consent information, which is the content of this decision, to the information brokering management device 1 (T9).

Having received this consent information (T10), the information brokering management device 1 confirms the consent on the basis of this consent information (T11) and issues a command for the process to prohibit the transfer of membership title to the membership management device 4, in order to prohibit the transfer of membership title after this time, on the basis of this consent (T12).

When the membership management device 4 receives this command (T13), the membership issuing organization carries out the process to prohibit the transfer of title to the membership (T14). When this process to prohibit the transfer of title is complete, the membership management device 4 sends the information regarding the completion of the process to prohibit the transfer of title to the information brokering management device 1 (T15). Having received this (T16), the information brokering management device 1 issues a command for the establishment of the credit line, already provided from the credit granting organization at T6, to the credit line management device 5 (T17). When the credit line management device 5 receives this command (T18), the credit granting organization establishes the credit line (T19). When this establishment of the credit line is complete, the credit line management device 5 sends the notification of the establishment of the credit line to the information brokering management device 1 (T20). Having received this notification of the establishment of the credit line (T21), the information brokering management device 1 sends this to the terminal device 2 (T22), and the terminal device 2 receives this (T23).

After this, the member will be able to go shopping on a network such as the Internet with the credit line, while carrying out processing with the same procedures as for a regular credit agreement, such as settling with the credit granting organization.

In the above-mentioned first method for electronically setting credits, it is preferable to use a digital processing device such as a personal computer for the terminal device. However, it is also possible to use an instrument for communicating by voice, such as a telephone, by providing an automatic voice response function to the information brokering management device.

The determination of the credit line, establishment of the credit line, or the process to prohibit the transfer of title which are carried out by the credit granting organization, which has the credit management device, or the membership issuing organization, which has the membership management device, may also be carried out automatically with data and programs in the credit line management device and the membership management device, or all or part of these processes may be carried out manually.

Also, the credit granting organization establishes the credit line without establishing security for the membership, but because the membership has undergone a process to prohibit the transfer of title, security interest can be established at any time and problems in this operation are thought to be small. Otherwise, the security interest may also be actually established for the membership by linking the credit granting organization and the membership issuing organization before establishing the credit line.

With this first method for electronically setting credits, a member can quickly and automatically receive a credit line if the member applies to a credit brokering organization to establish a credit line with the membership as security. Also, in case where that member uses a processing device that can be connected to the Internet such as a personal computer, the member can immediately use this credit line for commercial transactions on the network because the member can receive the establishment of the credit line over a network such as the Internet. Also, this credit line has as security a membership, that is a type of property and is managed by a membership issuing organization, and is a credit line that is backed by security, unlike unsecured credit lines based on preliminary examinations like in general credit agreements. Therefore, that member can make the best use of the asset value of this membership as security. Also, the rights of the membership can generally be used at the stage where this membership is established as security and therefore the member can use the credit line while enjoying the rights of the membership. Also, the credit granting organization can avoid the risk of a loan becoming unrecoverable, because security can be ensured for the establishment of the credit line, and can have increased opportunities to get new customers. Also, because all the information is sent and received through an information brokering management device, the information brokering management device can hold all the information and the credit brokering organization can gather and manage all the information.

In the above-mentioned first method for electronically setting credits, the credit granting organization determines the credit line with an independent determination. However, on the basis of the credit line application information from the member, the credit brokering organization can also acquire the market value information in advance from an appraisal organization, for appraising the market value and so forth of the membership, and provide this information to the credit granting organization through the information brokering management device.

In other words, a second method for electronically setting credits comprises the above-mentioned first method for electronically setting credits: wherein an appraisal management device possessed by an appraisal organization for appraising memberships is connected with the information brokering management device through the telecommunications network; and instead of sending the credit line application information directly to meet credit line management device, the information brokering management device sends the credit line application information to the appraisal management device; receives the market value information for the membership appraised by the appraisal organization from the appraisal management device; and sends this information along with the credit line application information to the credit line management device.

The above-mentioned second method for electronically setting credits is realized by adding the portion shown by the dotted lines in FIG. 1. In other words, the appraisal management device 3 possessed by an appraisal organization, for appraising the market value and so forth of the membership, is connected to the information brokering management device 1 through the telecommunications network 9. In the operation of this second method for electronically setting credits, the information brokering management device 1 sends the application information to the appraisal management device 3, instead of sending the credit line application information directly to the credit line management device 5 as in the operation of the first method for electronically setting credits. In other words, the process (b) is used instead of the process (a) in FIG. 2. In FIG. 2, when the credit line application information is sent from the terminal device 2 to the information brokering management device 1 (T1), the information brokering management device 1 receives this (T2) and sends this information to the appraisal management device 3 (T3). When the appraisal management device 3 receives this (T31), the appraisal organization carries out an appraisal of the membership on the basis of this credit line application information. The information management device 3 then sends the market value information for the membership based on this appraisal to the information brokering management device 1 (T32). The information brokering management device 1 receives this (T33) and sends this information along with the credit line application information to the credit line management device 5 (T34). The subsequent operations and actions are completely identical to the first method for electronically setting credits.

In the above-mentioned second method for electronically setting credits, the appraisal of the membership performed by the appraisal organization having the appraisal management device 3 may be carried out automatically by data and programs in the appraisal management device 3 or may be carried out manually, all or in part.

In the above-mentioned second method for electronically setting credits, the credit brokering organization acquires the market value information of the member's membership in advance through the information brokering management device 1, on the basis of the member's credit line application information, from the appraisal organization, which is an organization specifically for appraising the market value and so forth of the membership, and provides this information to the credit granting organization. For this reason, the credit granting organization does not need to conduct an investigation itself and can determine the credit line more easily and quickly than in the case of performing its own investigation. Consequently, the credit line can be granted to the member more quickly.

In the above-mentioned first and second methods for electronically setting credits, the information brokering management device may cause the credit line management device to notify the terminal device that the credit line has been established, rather than making that notification itself.

In other words, a third method for electronically setting credits comprises the above-mentioned first or second method for electronically setting credits: wherein, instead of the information brokering management device receiving the information regarding the completion of the process to prohibit the transfer of title from the membership management device, sending a command for establishing the credit line on the basis of the credit line information to the credit line management device, receiving the notification that the credit line has been established from the credit line management device, and sending this to the terminal device, the information brokering management device receives the information regarding the completion of the process to prohibit the transfer of title from the membership management device, and issues a command to the credit line management device for establishing the credit line on the basis of the credit line information and notifying the terminal device that the credit line has been established after the credit line is established.

The above-mentioned third method for electronically setting credits is realized by using (d) in FIGS. 2 and 3 instead of (c) in the operations in FIG. 2. Specifically, in FIGS. 2 and 3, when the information brokering management device 1 receives the information regarding the completion of the process to prohibit the transfer of title from the membership management device 4 (T16), the information brokering management device issues a command to the credit line management device 5 for establishing the credit line provided from the credit granting organization at T6 and, after this establishment, notifying the terminal device 2 that the credit line has been established (T161).

As a result, when the credit line management device 5 receives this command (T162), the credit granting organization carries out the establishment of the credit line (T163). When this is finished, the credit line management device 5 sends a notification that the credit line has been established to the terminal device 2 (T164) and the terminal device 2 receives this (T165).

In the above-mentioned third method for electronically setting credits, the information brokering management device does not itself notify the terminal device that the credit line has been established, but has the credit line management device do this and the terminal device is notified directly from the credit line management device. Consequently, the credit line can be granted to the member more quickly.

Next, the system for electronically setting credits relating to the present invention is explained. The first system for electronically setting credits relating to the present invention is essentially the following type of system.

Specifically, this is a system for electronically setting credits: wherein the terminal device operated by the member, the membership management device possessed by the membership issuing organization, and the credit line management device possessed by the credit granting organization are connected with the information brokering management device possessed by the credit brokering organization, for brokering the exchange of information among each of the devices, through the telecommunications network; and the information brokering management device comprises: means for receiving credit line application information sent from the terminal device; means for acquiring credit line information for sending this credit line application information to the credit line management device, and receiving credit line information, determined for the membership of the member by the credit granting organization, from the credit line management device; means for acquiring consent information for sending this credit line information to the terminal device, and receiving consent information decided upon by the member for this credit line information from the terminal device; means for commanding the prohibition of the transfer of membership title for sending a command for the process to prohibit the transfer of membership title to the membership management device on the basis of this consent information, and after the process to prohibit the transfer of title is performed by the membership issuing organization, for receiving the information that the process to prohibit the transfer of title is complete from the membership management device; means for commanding the establishment of the credit line for sending a command to establish the credit line on the basis of the credit line information, to the credit line management device, after receiving the information that the process to prohibit the transfer of title is complete, and for receiving the notification that the credit line has been established from the credit line management device after the credit line has been established by the credit granting organization; and means for reporting the establishment of the credit line to the terminal device.

FIG. 4 is a block diagram of this first system for electronically setting credits. This system is constituted of a terminal device 12 operated by the member having a membership such as a golf membership, a membership management device 14 possessed by a membership issuing organization for managing memberships, and a credit line management device 15 possessed by a credit granting organization for establishing credit lines for members on the basis of memberships connected to an information brokering management device 11 possessed by a credit brokering organization, for brokering the exchange of information among each of the devices, through a telecommunications network. These devices may be as follows for example: the terminal device 12 may be a telephone, personal computer, portable phone, or PDA; and the membership management device 14 and credit line management device 15 may be personal computers or computers. Also, means for receiving credit line application information 21, means for acquiring credit line information 23, means for acquiring consent information 24, means for commanding the process to prohibit the transfer of membership title 25, means for commanding the establishment of the credit line 26, and means for reporting the establishment of the credit line 27 are established in the information brokering management device 11.

The operations and actions of the first system for electronically setting credits are explained next based on FIG. 4. Moreover, the P character in the drawing shows the order of transmission of information and so forth.

In FIG. 4, in the case where a member owning a membership wants to establish a credit line, the credit line application information is sent by the operation of the terminal device 12 from this terminal device 12 to the means for receiving credit line application information 21 of the information brokering management device 11. Having received this (P1), the means for receiving credit line application information 21 transfer the credit line application information to the means for acquiring credit line information 23 (P2). This corresponds to the operation (a) in FIG. 4. Having received this, the means for acquiring credit line information send this credit line application information to the credit line management device 15 (P3).

When the credit line management device 15 receives this, the credit granting organization evaluates the membership, reaches a decision based on this credit line application information, determines the credit line information such as the amount of credit, and sends this credit line information from the credit line management device 15 to the means for acquiring credit line information 23.

Having received this (P4), the means for acquiring credit line information 23 send this credit line information to the means for acquiring consent information 24 (P5). Thereupon, the means for acquiring consent information 24 send this credit line information to the terminal device 12. When the terminal device 12 receives this (P6), the member decides whether to consent to receiving this credit line under conditions such as the amount of credit according to the credit line information provided. When the consent information which is the content of that decision is sent from the terminal device 12 to the means for acquiring consent information 24, the means for acquiring consent information 24 which received this (P7) send the consent information to the means for commanding the process to prohibit the transfer of membership title 25 (P8).

Having received this (P8), the means for commanding the process to prohibit the transfer of membership title 25 confirm the consent on the basis of this consent information and, in order to prohibit the transfer of membership title after this time, issue a command for the process to prohibit the transfer of membership title to the membership management device 14 on the basis thereof (P9).

When the membership management device 14 receives this command, the membership issuing organization carries out the prices to prohibit the transfer of title. After this process is completed, the membership management device 14 sends information regarding the completion of the process to prohibit the transfer of title to the means for commanding the process to prohibit the transfer of membership title 25 (P10). Having received this, the means for prohibiting for commanding the process to prohibit the transfer of membership title 25 send the information regarding the completion of the process to prohibit the transfer of title to the means for commanding the establishment of the credit line 26 (P11).

Having received this, the means for commanding the establishment of the credit line 26 command the establishment of the credit line, already provided from the credit line management device 15 at P4, to the credit line management device 15 (P12).

When the credit line management device 15 receives this command, the credit granting organization establishes the credit line. When this credit line is established, the credit line management device 15 sends a notification that the credit line has been established to the means for commanding the establishment of the credit line 26 (P13). Having received this notification that the credit line has been established, the means for commanding the establishment of the credit line 26 send this to the means for reporting the establishment of the credit line 27 (P14). The means for reporting the establishment of the credit line 27 send the notification that the credit line has been established to the terminal device 12 (P15), and the terminal device 12 receives this.

After this, the member will be able to go shopping on a network such as the Internet with the credit line, while carrying out processing with the same procedures as for a regular credit agreement, such as settling with the credit granting organization.

As discussed above, the operations and actions of this first system for electronically setting credits are entirely the same as the first method for electronically setting credits discussed above. Consequently, the same effects and comments as for the first method for electronically setting credits discussed above can be applied to this first system for electronically setting credits.

In the above-mentioned first system for electronically setting credits, the credit granting organization determines the credit line by an independent decision. However, on the basis of the credit line application information of the member, the credit brokering organization may also acquire the market value information in advance from the appraisal organization, for appraising the market value and so forth of the membership, and provide this information to the credit granting organization through the information brokering management device.

In other words, a second system for electronically setting credits comprises the above-mentioned first system for electronically setting credits: wherein the appraisal management device possessed by an appraisal organization for appraising memberships is connected with the information brokering management device through the telecommunications network; and the information brokering management device comprises means for acquiring the market value information for sending the credit line application information to the appraisal management device and receiving the market value information for the membership appraised by the appraisal organization from the appraisal management device; and means for acquiring the credit line information send the market value information along with the credit line application information to the credit line management device.

In FIG. 4, the above-mentioned second system for electronically setting credits further includes the appraisal management device 13 possessed by an appraisal organization for appraising the market value and so forth of the membership. In other words, this system is realized by adding the means for acquiring the market value information 22 to the information brokering management device 11, along with connecting the appraisal management device 13 to the information brokering management device 11 through the telecommunications network.

In the operation of this second system for electronically setting credits in the block diagram in FIG. 4, unlike the first system for electronically setting credits, the credit application information received by the means for receiving the credit line application information 21 is sent to the means for acquiring the market value information 22 instead of to the means for acquiring the credit line information 23. In other words, the process (b) is used instead of the process (a) in FIG. 4. Consequently, the operation of this system becomes as follows. In FIG. 4, when the credit line application information is sent from the terminal device 12 to the means for receiving the credit line application information (P1), the means for receiving the credit line application information 21 that received this send this credit line application information to the means for acquiring the market value information 22 (P21). Having received this, the means for acquiring the market value information 22 send this credit line application information to the appraisal management device 13 (P22). When the appraisal management device 13 receives this, the appraisal organization carries out an appraisal of the membership on the basis of this credit line application information, and then sends the market value information for the membership from the appraisal management device 13 to the means for acquiring the market value information 22 (P23). Having received this, the means for acquiring the market value information 22 send this market value information along with the credit application information to the means for acquiring the credit line information 23 (P24). Thereupon, the means for acquiring credit line information 23 send the market value information and credit line application information to the credit line management device 15 (P3). Subsequent operations are entirely the same as in the first system for electronically setting credits.

The operations and actions of this second system for electronically setting credits are the same as those of the second method for electronically setting credits discussed above. Consequently, the same effects and comments as for the second method for electronically setting credits discussed above can be applied to this second system for electronically setting credits.

In the above-mentioned first or second system for electronically setting credits, the information brokering management device may cause the credit line management device to notify the terminal device that the credit line has been established, rather than making that notification itself.

In other words, a third system for electronically setting credits comprises the above-mentioned first or second system for electronically setting credits, and employs means for commanding the establishment of the credit line and the reporting thereof for commanding the credit line management device to establish the credit line on the basis of the credit line information and to notify the terminal device that the credit line has been established after the credit line is established, instead of the means for commanding the establishment of the credit line and the means for reporting the establishment of the credit line.

In FIG. 4, the above-mentioned third system for electronically setting credits employs means for commanding the establishment of the credit line and the reporting thereof, instead of the means for commanding the establishment credit line 26 and the means for reporting the establishment of the credit line 27. As a result, the process (d) instead of the process (c) in FIG. 4 is used. In other words, the means for commanding the establishment of the credit line and the reporting thereof 28, which received the information regarding the completion of the process to prohibit the transfer of title from the means for commanding the prohibition of the transfer of membership title 25, (P111) command the credit line management device 15 to establish the credit line provided from the credit line management device 15 already at P4 (P112). As a result, the credit granting organization establishes the credit line. When this is finished, the credit line management device 15 sends the notification that the credit line has been established to the terminal device 12 (P113), and the terminal device 12 receives this.

As discussed above, the operations and actions of this third system for electronically setting credits are entirely the same as the third method for electronically setting credits discussed above. Consequently, the same effects and comments as for the third method for electronically setting credits discussed above can be applied to this third system for electronically setting credits.

A plurality of appraisal organizations can be used in the above-mentioned second or third system for electronically setting credits.

In other words, a fourth system for electronically setting credits comprises the above-mentioned second or third system for electronically setting credits; wherein a plurality of appraisal organizations which are provided appraisal management devices are established; and means for acquiring market value information send the same credit line application information to the plurality of appraisal management devices, receive a plurality of market value information, and use the market value information which is the greatest, least, or an intermediate value from among the information received.

With this fourth system for electronically setting credits, the means for acquiring market value information notify the plurality of appraisal management devices of the credit line application information sent from the terminal device, receive the plurality of market value information for the membership, and use the market value information which is the greatest, least, or an intermediate value from among the information received. As a result, by using one item of this market value information, the credit brokering organization can select policies for carrying out measures, that are advantageous for either the member or the credit granting organization, as policies for carrying out credit brokering.

It is also possible to use a plurality of credit granting organizations in these first through fourth systems for electronically setting credits discussed above.

In other words, a fifth system for electronically setting credits comprises the above-mentioned first through fourth system for electronically setting credits; wherein a plurality of credit granting organizations which are provided credit line management devices are established; and means for acquiring credit line information send the same credit line application information, or this credit line application information and market value information, to the plurality of credit line management devices, receive a plurality of credit line information, and command the establishment of the credit line to the credit line management device which sent the greatest credit line from among those received.

With this fifth system for electronically setting credits, the means for acquiring credit line information send the same credit line application information, or this credit line application information and market value information, to a plurality of credit line management devices, receive a plurality of pieces of credit line information provided therefrom, and command the establishment of the credit line to the credit line management device which provided the greatest credit line from among those. As a result, the member can get the greatest credit line that can be received with that membership as security.

It is also possible to use a plurality of membership issuing organizations in these first through fifth systems for electronically setting credits discussed above.

In other words, a sixth system for electronically setting credits comprises the above-mentioned first through fifth system for electronically setting credits; wherein a plurality of membership issuing organizations are established; and means for receiving credit line application information determine the membership issuing organizations on the basis of the credit line application information, while making the issuing organization determined be the membership issuing organization in the subsequent processes.

With this sixth system for electronically setting credits, means for receiving credit line application information differentiate the membership issuing organizations on the basis of the credit line application information, while making the membership management device of a differentiated membership issuing organization the device that is the subject of subsequent processes. As a result, members who are able to apply for credit can be expanded to the members of a plurality of membership issuing organizations.

In the first through sixth systems for electronically setting credits discussed above, it is also possible to connect the registration device of a registration organization to the information brokering management device, and to register to this registration device credit line application information or information relating to credit lines, the establishment of which has been commanded to credit line management devices.

In other words, a seventh system for electronically setting credits comprises the above-mentioned first through sixth systems for electronically setting credits; wherein a registration device of a registration organization are connected through a telecommunications network to the information brokering management device; and credit line application information, credit line information, or both are registered to the registration device.

With this seventh system for electronically setting credits, information relating to credit lines that have been established is registered to a registration device, and therefore the information relating to the credit lines that have been established can be read after registration and can be referenced in the operation of credit brokering by the credit brokering organization. Otherwise, in the case where there is some time between the member's request for a credit line until the credit line is actually established, the credit line brokering process can be managed with this registered information by erasing the registration once the credit line is actually established, after the registration of the credit line application information to the registration device.

### BRIEF DESCRIPTION OF THE DRAWINGS

FIG. 1 is a drawing of the system used in the first, second, and third methods for electronically setting credits relating to the present invention;

FIG. 2 is a drawing to explain the operations of the first, second, and third methods for electronically setting credits relating to the present invention;

FIG. 3 is a drawing to explain the operations of the third method for electronically setting credits relating to the present invention;

FIG. 4 is a block diagram of the first, second, or third system for electronically setting credits relating to the present invention;

FIG. 5 is a block diagram of a system for electronically setting credits relating to the embodiment;

FIG. 6 is an example of the information relating to the golf membership registered in the computer D in the embodiment; (a) is the time of the credit application, (b) is the time when the process to prohibit the transfer of title is commanded, and (c) is a table showing the status at the time of the establishment of the security interest;

FIG. 7 is a table showing an example of the appraisal standards for the golf membership registered in the computer C relating to the embodiment;

FIG. 8 is a table showing an example of the credit line response of the computer E in the embodiment; and

FIG. 9 is a table showing an example of the details of the credit line registered in the computer E in the embodiment.

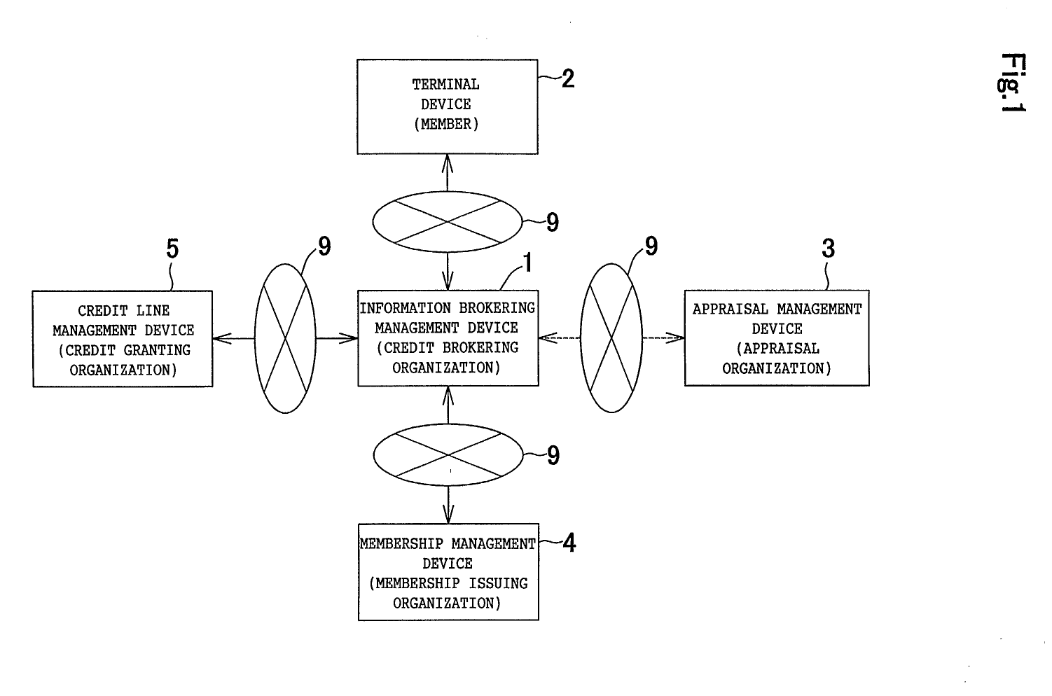

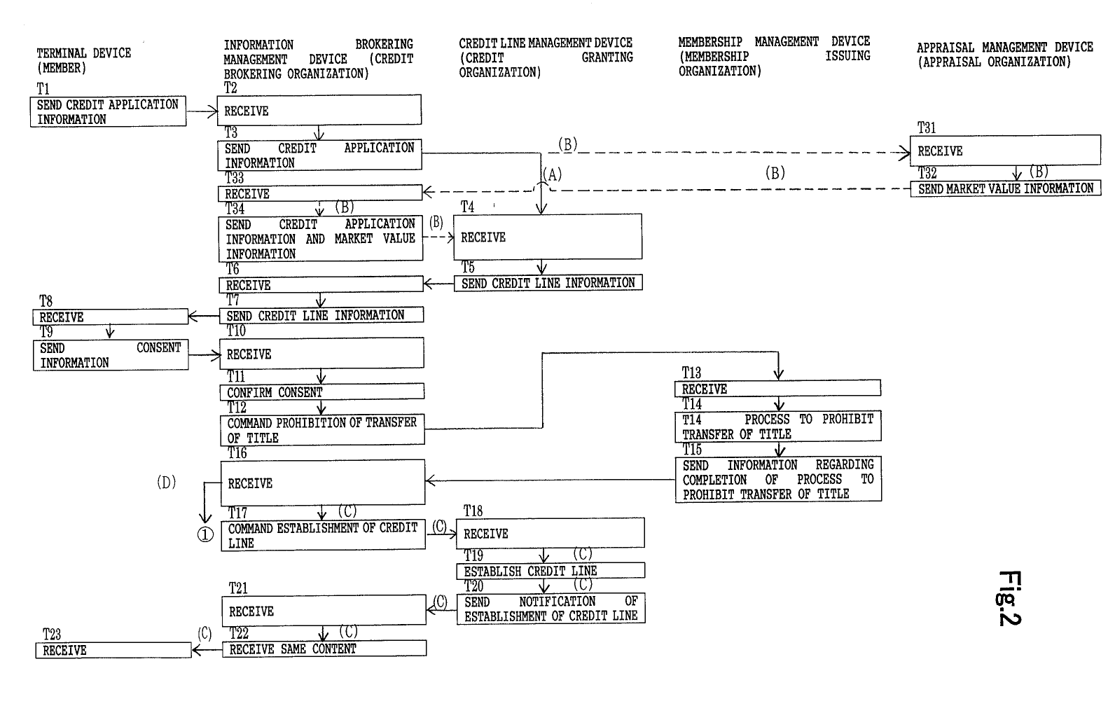

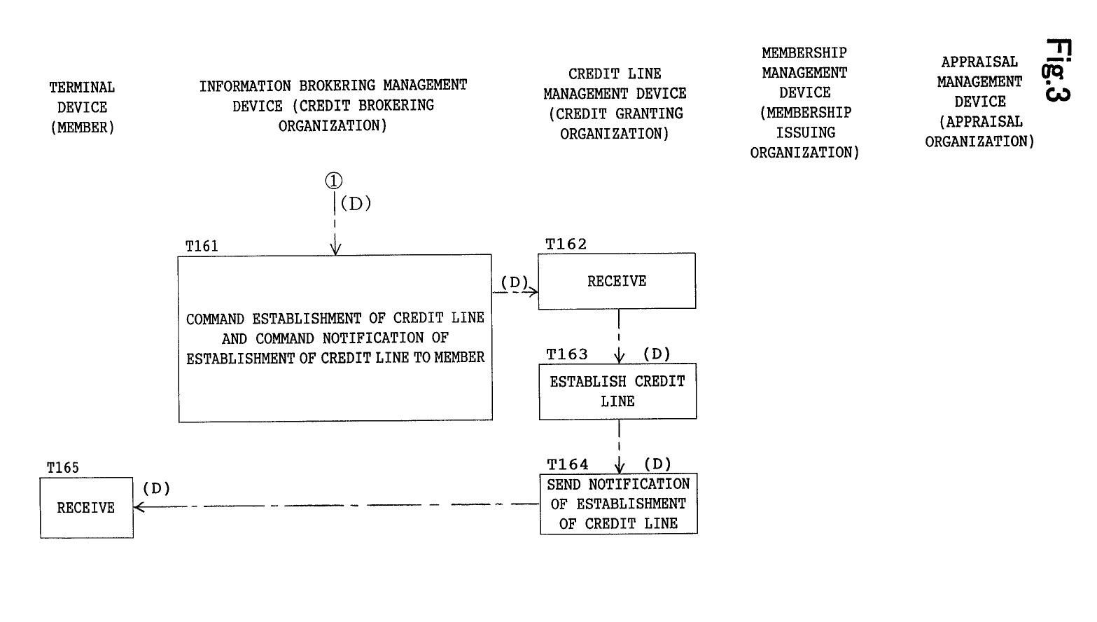

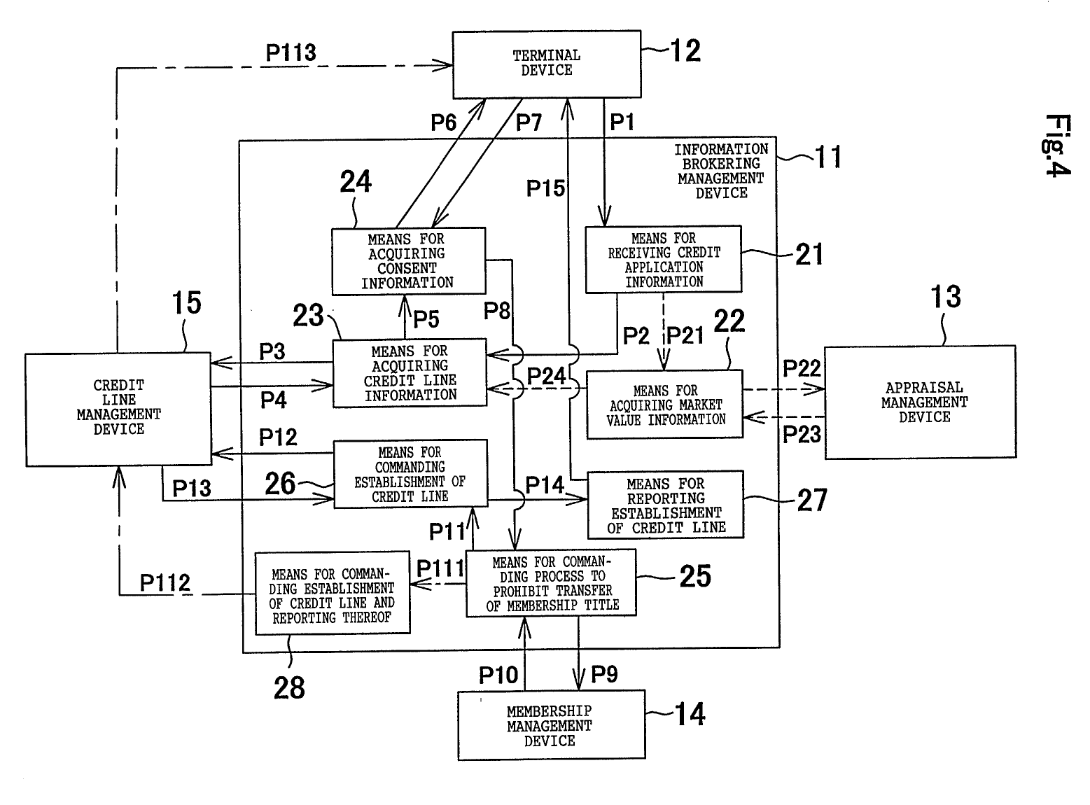

### DESCRIPTION OF THE PREFERRED EMBODIMENTS

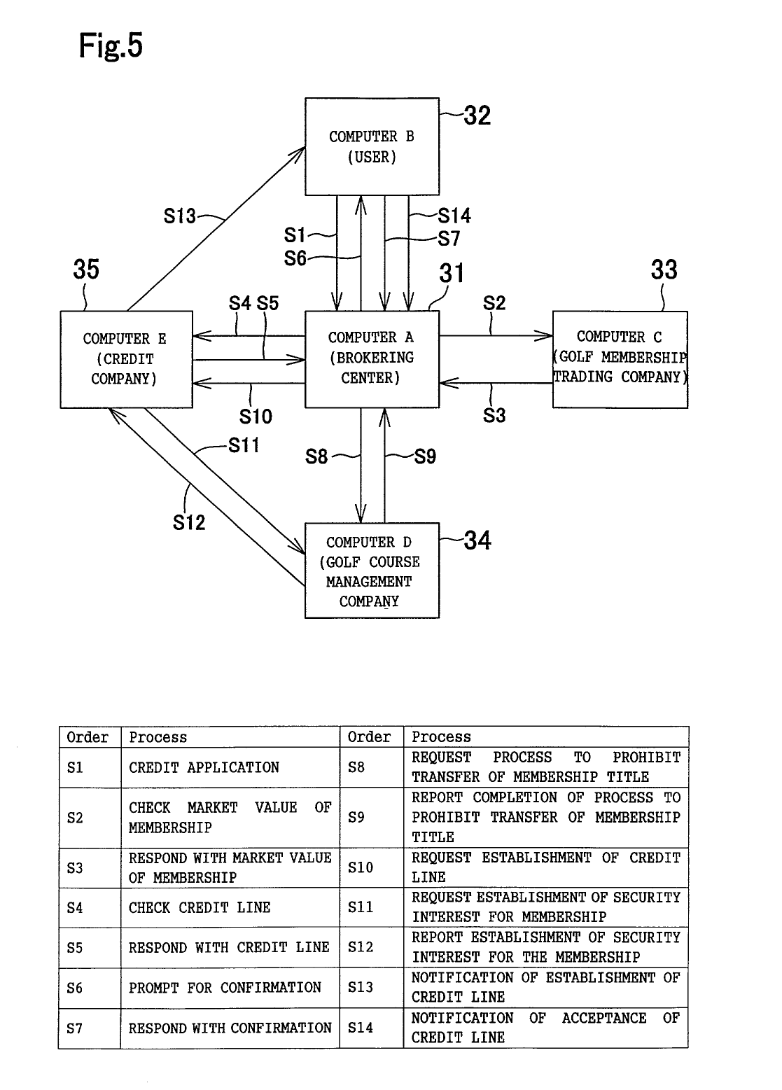

Next the preferred embodiments of the present invention are explained in detail with reference to the drawings. This system for electronically setting credits relating to the present embodiment is a system for establishing credit lines that can be used for shopping and the like in electronic stores on the Internet for users owning golf memberships, with these golf memberships as security. FIG. 5 is a block diagram of the system for electronically setting credits relating to the present embodiment. In FIG. 5, the system for electronically setting credits relating to the present embodiment comprises a computer B32 of a user owning a golf membership; a computer C33 of a golf membership trading company which buys and sells golf memberships and appraises golf memberships on the basis of the market value of the golf memberships; a computer D34 of a golf course management company which issues a golf memberships; a computer E35 of a credit company; and a computer A31 of a brokerage center which brokers the establishment of credit lines by the credit company with golf memberships as security. The computer B32, computer C33, computer D34, and computer E35 are connected through the Internet to the computer A31. Also, the computer B32 and computer D34 are connected through the Internet to the computer E35. Hardware and software necessary for connecting to the Internet and for their respective roles are provided in each of the above-mentioned computers.

Moreover, in the present embodiment, a personal computer is representative of the user's computer B32, but a portable phone, PDA, or the like including software may also be used. Also, the computer A31 communicates with the user through the computer B32, but systems allowing voice communications, using a telephone instead of the computer B32, are also considered.

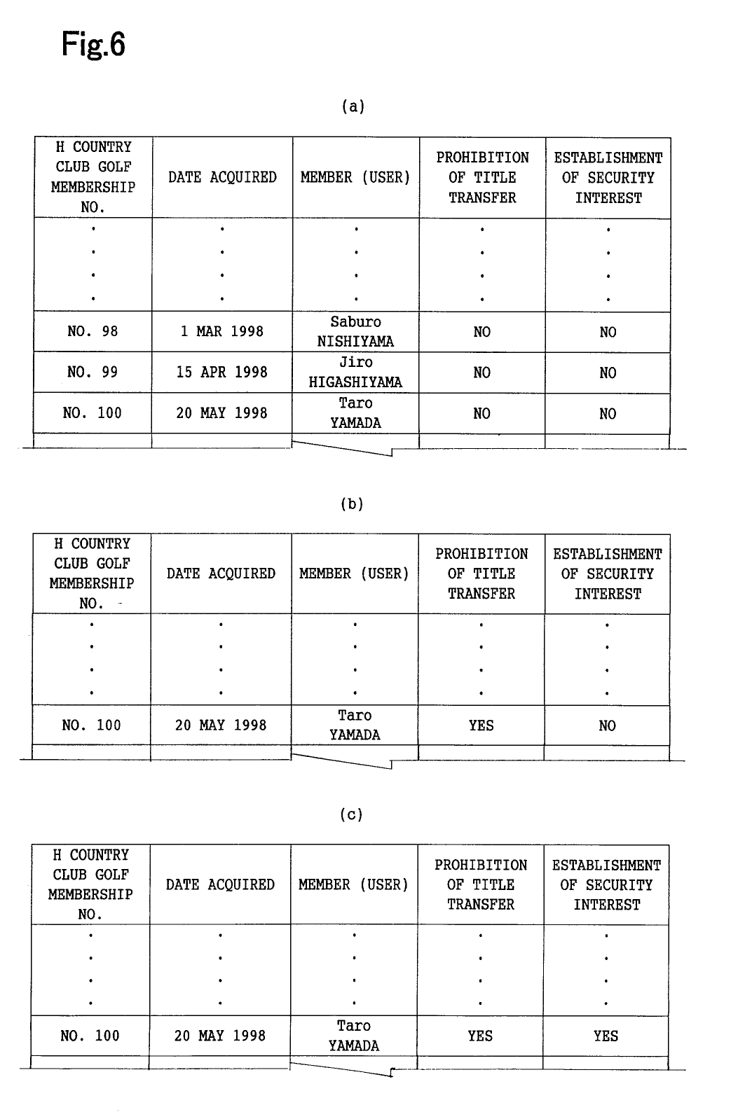

Next, the operations and actions of the system for electronically setting credits relating to the present embodiment are explained on the basis of FIG. 5. Moreover, the S numbers in the drawing show the order of the processes. In the present embodiment, the user Robert Smith owns a golf membership, membership No. 100 in the golf course H country club, owned by a golf course management company. This golf membership is registered to the computer D34 as shown in FIG. 6(a).

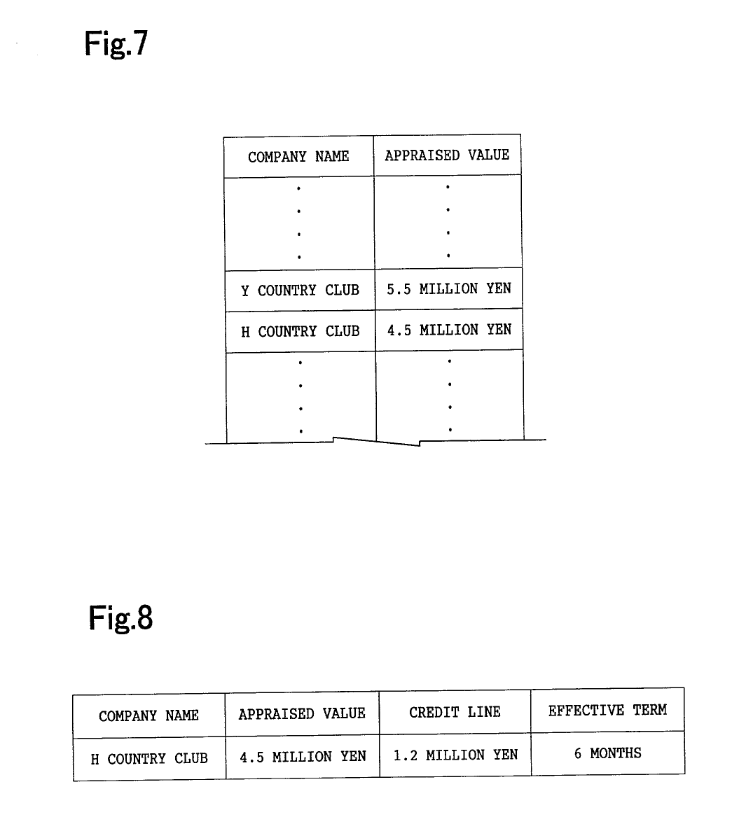

In the case where the user wants to establish a credit line with this golf membership as security, the user sends a credit application, including the user name and the name of the golf course in which he has a membership, to the computer A31 by operating the computer B32 (S1). Having received the transmission, the computer A31 checks the computer C33 for the market value of the golf membership on the basis of this credit application (S2). The computer C33 is provided an appraisal criteria chart for golf memberships as shown in FIG. 7, for example, and responds to the computer A31 with the appraisal amount of 4.5 million yen for an H country club golf membership, this being the market value for the golf membership, on the basis thereof (S3). Having received the response, the computer A31 checks the computer E35 for the amount of the credit line that can be established with this golf membership as security on the basis of this market value (S4). With an independent determination, such as calculating the amount of money by multiplying the market value by a standard percentage, the computer E35 decides upon 1.2 million yen, for example, as the credit line with an H country club golf membership as security and responds to the computer A31 with the credit line information as shown in FIG. 8 (S5).

With this response, the computer A31 sends this credit line information to the computer B32 and requests approval or disapproval from the user (S6). The user operates the computer B32 according to whether he is satisfied with the amount of money for the credit line provided and responds with approval or disapproval. This response is sent from the computer B32 to the computer A31 (S7); in the case of disapproval, the processing stops at that point. In the case of approval, presupposing that the golf membership is established as security, a request to prohibit the transfer of title of the golf membership is sent from the computer A31 to the computer D34 in order to prohibit the transfer of title to the golf membership (S8). Thereupon, the computer D34 carries out the process to prohibit the transfer of title, changes the registered golf membership information as shown in FIG. 6(b), for example, and sends the report that the process to prohibit the transfer of title is complete to the computer A31 (S9). Thereupon, on the basis of the report that this process to prohibit the transfer of title is complete, the computer A31 commands the computer E35 to establish the credit line already provided from the computer E35 and to notify the computer B32 that the credit line has been established, to be carried out after the computer E35 establishes the credit line (S10).

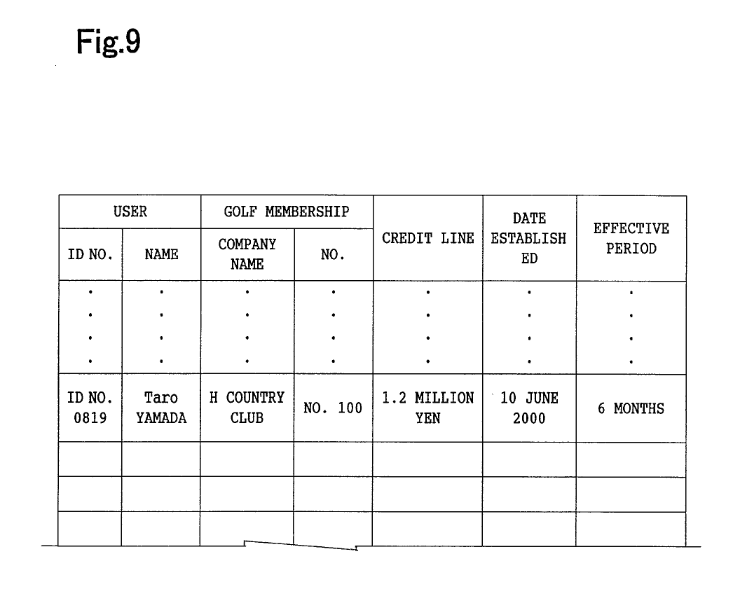

Having received the command to establish the credit line, the computer E35 sends a request to establish the security interest for the golf membership to computer D34 (S11). Thereupon, the computer D34 establishes the security interest for the golf membership and changes the registered golf membership information as shown in FIG. 6(c), for example, while sending a report that the security interest is established to the computer E35 (S12). Upon receiving this report of the establishment of the security interest, the computer E35 registers to itself the credit line information as shown in FIG. 9, for example, and sends a notification that the credit line is established to the computer B32 to inform the user that the credit line has actually been established (S13). When the user then operates the computer B32 to confirm the establishment of the credit line, a credit line acceptance notification is sent from the computer B32 to the computer A31 (S14), the computer A31 understands that the establishment of the credit line with the golf membership as security has been completely finished, and the series of processes ends.

After the establishment of the credit line is completed in this way, the user will be able to go shopping on a network such as the Internet with the credit line, while carrying out processing with the same procedures as for a regular credit agreement, such as settling with the credit granting organization. Moreover, the use of the credit line established as above naturally includes use for commercial transactions over a network as discussed above, but is not limited to this and can also include use as means for settlement in any case that one might think of. Also, it is conceivable that a credit company will issue special cards granting credit lines with memberships as security to create a convenience for users.

With the system for electronically setting credits relating to the present embodiment as discussed above, the amount of the credit line determined is based only on the market value of the golf membership when the credit line information is determined. However, the amount of the credit line can also be based on the amount of the membership deposit and the repayment date for the deposit. In this case, this information can be provided by the user when applying for credit, or the computer A31 can check the computer D34 for information relating to the amount of the membership deposit and the repayment date of the deposit before the computer A31 checks the computer E35 for the credit line, and this information can be sent at the same time that the computer A31 checks the computer E35 for the credit line.

Also, the contents of the credit line response of the computer E35 generally relate to the amount of credit and the effective period. However, a system wherein the user can borrow from the credit company with this credit line is also considered and in this case, information such as the interest can also be included in the contents of the credit line response.

In order for the above-mentioned embodiment to operate smoothly, the legal background is necessary. At the start of the operation of the present embodiment, the following points must be considered. In other words, in order for the process carried out by a system for electronically setting credits relating to the present embodiment to be legally valid, the parties participating in the assistant for electronically setting credits relating to the present embodiment, meaning the user, the golf membership trading company, the golf course management company, the credit company, and the brokering center, must conclude agreements with each other in advance.

Also, in the system for electronically setting credits relating to the present embodiment, the golf membership must be liquidated in the case where it is impossible to recover the money used by the user with the credit line established by the credit company, and the golf membership being transferable is a precondition. In some cases, for example, the articles of incorporation of the golf course management company include a system for transferring golf memberships in which the approval of the board of directors is necessary when transferring title. When liquidating a golf membership in this type of golf course, it then becomes necessary to get the authorization of the board of directors one by one and this is not practical because of the work involved. For this reason, it is necessary in such cases to establish transfer procedures, such as in the articles of incorporation of the golf course management company, in advance.

Also, a membership such as a golf course membership may sometimes involve the issuing of a certificate as proof thereof by the issuing organization, and such a certificate generally is retained by the organization that issued the membership. In the present embodiment as well, in the case where a certificate of membership in the H country club is issued, this certificate is preferably retained by the golf course management company.

With the system for electronically setting credits relating to the present embodiment as above, if an application to establish a credit line with the golf membership as security is made from the computer B32 to the computer A31 by the user operating the computer B32, this credit line can be immediately used for commercial transactions on the network because the credit line can be received automatically and smoothly over the network. Also, this credit line has as security a golf membership that is a type of property managed by the computer D34, and maximum use can be made of the asset value of the golf membership because this is a secured credit line, unlike unsecured credit lines based on a preliminary examination like a general credit agreement. Moreover, at the stage of establishing the golf membership as security, one can generally exercise the basic right to be able to use the golf course in which one has membership; one can therefore enjoy the basic rights for the asset of membership, while being able to use the credit line. Also, the credit company can avoid the risk of a loan becoming unrecoverable, because security can be ensured for the establishment of the credit line, and can have increased opportunities to get new customers.

In the system for electronically setting credits relating to the present embodiment above, there is one golf membership trading company, but there may be more than one and a plurality of computers C33 may also be established. In other words, in the system for electronically setting credits relating to the present embodiment above, the computer A31 of the brokering center is connected through the Internet to a plurality of computers C33 of golf membership trading companies. The computer A31 checks the market value of the golf membership with the plurality of computers C33 and uses the market value information which is the greatest, least, or an intermediate value from among the plurality of market values received.

Depending on which market value is used, the brokering center can select policies for carrying out measures, that are advantageous for either the member or the credit granting organization, as policies for carrying out credit brokering.

Otherwise, in the system for electronically setting credits relating to the embodiment above, the market value of the golf membership acquired from the computer C33 of the golf membership trading company by the computer A31 is used for provision to the computer E35. However, because the credit company that is provided the computer E35 can also evaluate the market value of the golf membership with an independent examination, it is also possible to have, oppositely, a system wherein the computer C33 of the golf membership trading company is omitted from the system for electronically setting credits.

In the system for electronically setting credits relating to the present embodiment above, there is one credit company, but there may be a plurality of credit companies and a plurality of computers E35. In other words, in the system for electronically setting credits relating to the present embodiment above, the computer A31 of the brokerage center, the computer B32 of the user, and the computer D34 of the golf course management company are each connected through the Internet with the computers E35 of the plurality of credit companies. The computer A31 checks the plurality of computers E35 for the credit lines, and makes a request for establishing the credit line to the computer E35 that provided the credit line for the greatest amount, from among the plurality of credit lines received.

In this case, the computer A31 checks the plurality of computers E35 for the credit line and makes a request for establishing the credit line to the computer E35 that provided the greatest credit line from among the plurality of credit lines received. As a result, the user can get the greatest credit line that can be received with the golf membership as security.

In the system for electronically setting credits relating to the embodiment above, there is one golf course management company, but there may be a plurality of golf course management companies and a plurality of computers D34. Another words, in the system for electronically setting credits relating to the embodiment above, the computer A31 of the brokerage center is connected through the Internet to the computers C33 of a plurality of golf course management companies. When the credit application including the golf course name for the golf membership is sent from the user's computer B32 to the computer A31 of the brokerage center, the computer A31 determines the golf course name of the golf membership and makes a request to prohibit the transfer of title of the golf membership to the computer D34 of the company that manages the golf course determined. Also, the computer E35 makes a request to establish security interest to the computer D34 of the company that manages the golf course determined.

In this case, the computer A31 carries out each process after determining the golf course name of the golf course membership. As result, the opportunity to apply for credit can be extended to persons owning memberships in a plurality of golf courses.

In the system for electronically setting credits relating to the present embodiment above, the computer E35 makes a request to the computer D34 to establish security interest for the golf membership, before the computer E35 establishes the credit line, and thereby actually establishes the security interest for the golf membership. So long as the process to prohibit the transfer of membership title is complete, security interest can be established at any time in the case where the necessity to establish security interest arises. Because it is thought that there are few problems in operations, the credit line may also be established with just the process to prohibit the transfer of title by the computer D34 and without establishing security interest for the golf membership.

Also, in the system for electronically setting credits relating to the present embodiment above, because it is actually communicated to the user that the credit line is established after the computer E35 actually establishes the credit line, the notification of the establishment of the credit line is sent directly from the computer E35 to the computer B32. However, after the computer E35 establishes the credit line, a message that the credit line has been established may also be sent to the computer A31, such that the notification that the credit line has been established may be sent from the computer A31 to the computer B32. Also, before the computer E35 establishes the credit line, a request to establish security interest for the golf membership is made to the computer D34, but this may also be carried out through the computer A31. In this case, notification that the security interest has been established is made through the computer A31. When this type of method is employed, the computer A31 can acquire all the information and can collect and manage all the information because all the information is sent through the computer A31.

Also, in the system for electronically setting credits relating to the present embodiment above, information relating to the credit application or information relating to the credit line commanded by the credit line management device may be stored to this registration organization computer by having the registration organization computer, owned by a registration organization, connected to the computer A31 of the brokering center.

In this case, because information relating to the credit line commanded is stored in the registration organization computer, it is possible to read information relating to the credit line commanded after registration and to reference the credit brokering operations of the credit brokering center. In the case where time passes between the request to establish the credit line from the member until the credit line is actually established, the progress of the credit line brokering can be managed with this registered information by erasing the registration once the credit line is actually established after registering information relating to the credit application to the registration organization computer.

Also, this registration organization and brokering center may be combined and the registration organization computer and computer A31 may be the same computer.

Also, in the system for electronically setting credits relating to the present embodiment above, the golf membership trading company, golf course management company, and credit company automatically perform their respective processing with their own computers, but all or part of the processing may be performed manually by employees at each company.

Also, as a mode for operating the system for electronically setting credits relating to the present embodiment above, all or part of the transmission of information among the computers may be done by people using telephones or the like, or inputting this information manually to the computer A.

Also, in the system for electronically setting credits relating to the present embodiment above, the brokering center is an independent organization, but may also be combined with other organizations. For example, in the system for electronically setting credits relating to the present embodiment above, the brokering center and credit company may be combined and the computer A31 and computer E35 may be realized with one computer. In this case, the credit company substantially operates the brokering center and can expand into new business fields in addition to its traditional business. Also, the brokering center and golf membership trading company may be combined and the computer A31 and computer C33 may be realized with one computer. In this case, the golf membership trading company substantially operates the brokering center and has the same advantages as above. Also, the brokering center and golf course management company may be combined as above and the computer A31 and computer D34 can be realized with one computer; this case also has the same advantages as above. Also, a method wherein three organizations, the brokering center, golf course trading company, and credit company, among the organizations constituting the system for electronically setting credits are combined is also considered.

In the system for electronically setting credits relating to the present embodiment above, the membership used was a golf membership, but is not limited to this and may be a membership including rights whereby a set of services can be received, such as a resort condominium membership, or something having similar asset value. It is possible to use anything so long as it is possible to have a process to prohibit the transfer of title.

With the method for electronically setting credits according to the first point of the present invention or the system for electronically setting credits according to the fourth point of the present invention, the member can automatically and quickly receive a credit line if the member makes an application to establish a credit line with the membership as security to a credit brokering organization. Also, in the case where the member uses a processing device that can be connected to the Internet such as a personal computer, the member can have the line of credit established over a network such as the Internet and therefore the member can immediately use this credit line for commercial transactions on the network. Also, this credit line has as security a membership, that is a type of property managed by a membership issuing organization, and is a credit line that is backed by security, unlike an unsecured credit line based on a preliminary examination like general credit agreements. Therefore, maximum use can be made of the asset value of the membership as security. Moreover, at the stage of establishing the membership as security, one can generally exercise the basic rights of membership; one can therefore enjoy the basic rights of membership, while being able to use the credit line. Also, the credit granting organization can avoid the risk of a loan becoming unrecoverable, because security can be ensured for the establishment of the credit line, and can have increased opportunities to get new customers. Also, because all the information is sent and received through an information brokering management device, the information brokering management device can hold all the information and the credit brokering organization can gather and manage all the information.

With the method for electronically setting credits according to the second point of the present invention or the system for electronically setting credits according to the fifth point of the present invention, the credit brokering organization acquires the market value information of the member's membership in advance, through the information brokering management device, from an appraisal organization that is a specialized organization for appraising the market value and so forth of memberships, on the basis of the credit line application information of the member; and the credit brokering organization provides this information to the credit granting organization. For this reason, the credit granting organization does not need to make its own investigation and can determine the credit line more easily and quickly than in the case of making its own investigation. Consequently, the credit line can be granted to the member quickly.

With the method for electronically setting credits according to the third point of the present invention or the system for electronically setting credits according to the sixth point of the present invention, the information brokering management device does not itself notify the terminal device that the credit line has been established, but causes the credit line management device to carry this out; and the terminal device is notified directly from the credit line management device. Consequently, the credit line can be granted to the member quickly.

With the system for electronically setting credits according to the seventh point of the present invention, the means for acquiring market value information notify a plurality of appraisal management devices of the credit line application information sent from the terminal device, receive a plurality of market value information for the membership, and use the market value information which is the greatest, least, or an intermediate value from among the information received. By using any of this market value information, the credit brokering organization can therefore select policies for carrying out measures, that are advantageous for either the member or the credit granting organization, as policies for carrying out credit brokering.

With the system for electronically setting credits according to eighth point of the present invention, the means for acquiring credit line information send market value information relating to the membership received by the means for acquiring market value information from the appraisal management device, along with the credit line application information to a plurality of credit line management devices, receive a plurality of credit line information, and command the establishment of the credit line to the credit line management device which provided the greatest credit line from among those received. As a result, the member can get the greatest credit line that can be received with that membership as security.

With the system for electronically setting credits according to ninth point of the present invention, the means for receiving credit line application information determine the membership issuing organization from the credit line application information and make the membership management device of the membership issuing organization determined be the subject of the following processing. As result, the opportunity to apply for credit can be extended to persons owning memberships in a plurality of membership issuing organization.

With the system for electronically setting credits according to the tenth point of the present invention, the information relating to the credit line established is registered to a registration device and therefore the information relating to the credit lines that have been established can be read after registration and can be referenced in the operation of credit brokering by the credit brokering organization. Otherwise, in the case where there is some time between the member's request for a credit line until the credit line is actually established, the credit line brokering process can be managed with this registered information by erasing the registration once the credit line is actually established, after the registration of the credit line application information to the registration device.

What is claimed is:

1. A method for electronically setting credits,
wherein a terminal device operated by a member, a membership management device possessed by a membership issuing organization, and a credit line management device possessed by a credit granting organization are connected through a telecommunications network to an information brokering management device possessed by a credit brokering organization for brokering the exchange of information among each of said devices; and
wherein this information brokering management device receives credit line application information sent from said terminal device and sends this to said credit line management device; receives credit line information determined for the membership of said member by said credit granting organization from said credit line management device, and sends this information to said terminal device;
when consent information decided upon by said member for said credit line is received from said terminal device, on the basis of this consent information, this information brokering management device commands a process to prohibit the transfer of title of said membership to said membership management device;
after said process to prohibit the transfer of title is carried out by said membership issuing organization, this information brokering management device receives information regarding the completion of the process to prohibit the transfer of title from said membership management device, and commands the establishment of said credit line on the basis of said credit line information to said credit line management device; and
after said credit line is established by said credit granting organization, this information brokering management device receives notification that said credit line is established from said credit line management device, and sends this information to said terminal device.

2. The method for electronically setting credits, according to claim 1,
wherein an appraisal management device possessed by an appraisal organization for appraising said membership is connected through said telecommunications network to said information brokering management device; and
wherein, instead of sending said credit line application information to said credit line management device, said information brokering management device sends said credit line application information to said appraisal management device, receives market value information for said membership appraised by said appraisal organization from said appraisal management device, and sends this along with said credit line application information to said credit line management device.

3. The method for electronically setting credits, according to claim 1 or 2:
wherein, instead of receiving information regarding the completion of said process to prohibit the transfer of title from said membership management device, commanding the establishment of said credit line on the basis of said credit line information to said credit line management device, receiving a notification that said credit line is established from said credit line management device, and sending this information to said terminal device, said information brokering management device receives information regarding the completion of said process to prohibit the transfer of title from said membership management device, and commands said credit line management device to establish said credit line on the basis of said credit line information, and to notify said terminal device that said credit line is established after the establishment of the credit line.

4. A system for electronically setting credits,
wherein a terminal device operated by a member, a membership management device possessed by a membership issuing organization, and a credit line management device possessed by a credit granting organization are connected through a telecommunications network to an information brokering management device possessed by a credit brokering organization for brokering the exchange of information among each of said devices; and
wherein said information brokering management device comprises:
means for receiving credit line application information sent from said terminal device;
means for acquiring credit line information for sending the credit line application information to said credit line management device, and receiving credit line information determined for the membership of said member by said credit granting organization from said credit line management device;
means for acquiring consent information for sending this credit line information to said terminal device, and receiving consent information decided upon by said member for said credit line information from said terminal device;
means for commanding a process to prohibit the transfer of title of membership for issuing, on the basis of this consent information, a command for the process to prohibit the transfer of title of said membership to said membership management device, and receiving information regarding the completion of said process to prohibit the transfer of title from said membership management device after said process to prohibit the transfer of title is carried out by said membership issuing organization;
means for commanding the establishment of the credit line for commanding the establishment of said credit line, on the basis of said credit line information, to said credit line management device after the reception of said information regarding the completion of the process to prohibit the transfer of title, and receiving notification that said credit line has been established from said credit line management device after said credit line has been established by said credit granting organization; and
means for reporting the establishment of the credit line for sending notification that said credit line has been established to said terminal device.

5. The system for electronically setting credits, according to claim 4,
wherein an appraisal management device possessed by an appraisal organization for appraising said membership is connected through said telecommunications network to said information brokering management device; and
said information brokering management device comprises means for acquiring market value information for sending said credit line application information to said appraisal management device, and receiving market value information for said membership appraised by said appraisal organization from said appraisal management device; and
said means for acquiring credit line information sends said market value information, along with said credit line application information, to said credit line management device.

6. The system for electronically setting credits, according to claim 4 or 5, wherein means for commanding the establishment of the credit line and the reporting of the establishment of the credit line are used instead of said means for commanding the establishment of the credit line and said means for reporting the establishment of the credit line;
said means for commanding the establishment of the credit line and the reporting of the establishment of the credit line commanding, to said credit line management device, the establishment of said credit line on the basis of said credit line information, after the reception of information regarding the completion of said process to prohibit the transfer of title, and the notification of the establishment of said credit line to said terminal device after the establishment is complete.

7. The system for electronically setting credits, according to claim 5 or 6, wherein a plurality of said appraisal organizations which are provided said appraisal management devices is established; and
said means for acquiring market value information send said credit line application information identically to the plurality of said appraisal management devices, receive a plurality of said market value information, and use said market value information which is the greatest, the least, or an intermediate amount from among the information received.

8. The system for electronically setting credits, according to any of claims 4 through 7, wherein a plurality of said credit granting organizations possessing said credit line management devices is established; and
said means for acquiring said credit line information send said credit line application information, or this credit line application information and said market value information, identically to said plurality of credit line management devices, receive a plurality of said credit line information, and command the establishment of said credit line to said credit line management device that sent said credit line of the greatest amount from among the information received.

9. The system for electronically setting credits, according to any of claims 4 through 8, wherein a plurality of said membership issuing organizations in established; and
said means for receiving said credit line application information determines the issuing organization of said membership on the basis of said credit line application information, and makes the issuing organization determined said membership issuing organization in the subsequent processing.

10. The system for electronically setting credits, according to any of claims 4 through 9, wherein a registration device possessed by a registration organization is connected through said telecommunications network to said information brokering management device; and
said credit line application information, said credit line information, or both are registered in said registration device.
